(19) United States
(12) Patent Application Publication
(10) Pub. No.: US 2011/0163132 A1
(43) Pub. Date: Jul. 7, 2011

(54) Dispensing cap, container and method for dispensing contents

(76) Inventor: Fabrice Moreau, Tassin la Demi Lune (FR)

(21) Appl. No.: 12/928,078

(22) Filed: Dec. 2, 2010

Related U.S. Application Data
(60) Provisional application No. 61/265,949, filed on Dec. 2, 2009.

(51) Int. Cl. G01F 11/26; B65D 47/00

(52) U.S. Cl. 222/454; 222/548

(57) ABSTRACT

To further develop a closure, especially a cap, of a container, this invention provides a cap for a container with a mouth such as a bottle, including a lower part for attachment to the mouth of the container, and an upper part provided on and rotatable relative to the lower part, wherein the upper part has a dispensing orifice and the lower and upper parts can be rotated into the following positions. A first position where there is no passage through the cap and the contents of the container cannot be dispensed from the dispensing orifice. A second position where there is a straight passage through the cap and the contents of the container can be dispensed from the dispensing orifice by pouring or scattering. A third position where there is a sinuous passage through the cap, and the contents of the container to be dispensed from the dispensing orifice is in a preset dosed quantity.

The entire disclosure of U.S. Provisional Patent Application 61/265,949, filed 2 Dec. 2009, to which a priority benefit is claimed by this U.S. patent application under Title 35, United States Code, Section 119 and/or 120, including the entire teachings are incorporated, by reference, into this specification. This U.S. patent application claims the priority benefit of U.S. Provisional Patent Application 61/265,949, filed on 2 Dec. 2009.

### BACKGROUND OF THE INVENTION

1. Field of the Invention

This invention relates to a cap for a container with a mouth such as a bottle, including a lower part for attachment to the mouth of the container, and an upper part provided on and rotatable relative to the lower part, wherein the upper part has a dispensing orifice and the upper part can be rotated.

This invention also relates to a cap for a container with a mouth such as a bottle, including a lower part for attachment to the mouth of the container, an upper part provided on the lower part and a partition within the cap to divide the cap into a first section and into at least one further section, wherein the upper part has a dispensing orifice.

This invention also relates to a container with a mouth and a closure of the mouth.

This invention also relates to a method for dispensing contents with a closure of a container, whereby the contents can be dosed by turning the container so that the contents can follow a sinuous path through the closure by redirecting of two radially spaced barriers of the closure.

2. Discussion of Related Art

Caps for containers where the cap can be manipulated between a closed position where the contents of the container cannot be dispensed and an open position where the contents of the container can be poured out or scattered are known. For example, caps for containers for sugar strands or similar sweet toppings usually have a pouring or scattering aperture, which can be opened and closed by a hinged flap attached to the cap. Such caps may alternatively be formed with a part connected to the container, and a rotatable part, both of which have apertures. The parts can be rotated relative to one another to bring the apertures into and out of alignment, allowing the contents to be sprinkled out of the container when the apertures are aligned, and preventing this when the apertures are not aligned.

Container closures are also known which allow the contents of the container to be dispensed in dosed quantities. For example, cartons of washing powder can have such closures, which allow a metered dose of washing powder to be dispensed each time from the container.

However, there are some products for which it would be desirable to be able to dispense them in both of the ways mentioned above, poured and in metered doses.

### SUMMARY OF THE INVENTION

One object of at least the preferred embodiments of this invention is to provide a closure for a container which allows the contents of the container to be dispensed both ways.

According to a first aspect of this invention, a cap for a container with a mouth such as a bottle, includes a lower part for attachment to the mouth of the container, and an upper part provided on and rotatable relative to the lower part, wherein the upper part has a dispensing orifice and the lower and upper parts can be rotated into: a first position, where there is no passage through the cap and the contents of the container cannot be dispensed from the dispensing orifice; a second position, where there is a straight passage through the cap and the contents of the container can be dispensed from the dispensing orifice by pouring or scattering; and a third position, where there is a sinuous passage through the cap, and the contents of the container to be dispensed from the dispensing orifice in a preset dosed quantity.

Thus, the contents of the container can be dispensed in two different ways, by pouring and scattering and in dosed quantities, and the container can also be closed when not in use. As the cap is moved between the first, second and third positions by relative rotation of the parts of the cap, there is no risk of a part of the cap becoming lost, as would be possible if a part of the cap had to be removed altogether to allow dispensing.

Preferably, the cap is placed at a neck of the container.

For another object of this invention, a cap for a container with a mouth such as a bottle, including lower part for attachment to the mouth of the container, an upper part provided on the lower part and a partition within the cap to divide the cap into a first section and into at least one further section, wherein the upper part has a dispensing orifice, whereby the partition includes a first element and at least a further element, whereby the elements are arranged moveable to each other to provide either a straight passage or a sinuous passage through the cap.

Such a cap can be handled in a very simple manner. Different functions, for example poured and metered doses, can be obtained without any problems.

Advantageously, the first element of the partition is rotatable in relation to the further element of the partition to provide either a straight passage or a sinuous passage through the cap. The first element can be an upper blade of the cap and the further element can be a lower blade of the cap.

The cap can be designed in a particularly simple manner, when the first element of the partition can be rotated around the main axis of the cap.

Advantageously, the elements of the partition are radially spaced apart from the main axis of the cap. In this embodiment, the inside of the cap can be formed asymmetrically in a simple manner. So either a straight passage or a sinuous passage through the cap can easily be provided.

In a further advantageous exemplary embodiment, the first element of the partition includes the upper part and the further element of the partition includes the lower part. Thus the cap can have a very compact design.

It is possible to provide the dispensing orifice on any part of the cap. However, in a preferred form, the lower part and the upper part are generally rotationally symmetric around the main axis of the cap and/or of the mouth of the container, the upper part rotates around this axis, and the dispensing orifice of the upper part is provided in a planar portion generally perpendicular to the axis. The cap can then be moved between its various positions by rotating the upper part of the cap, which is a natural and familiar action.

Any suitable rotator or means can be provided to allow the upper part of the cap to rotate on the lower part of the cap. Preferably, the lower part of the cap has a cylindrical wall defining a passage therethrough, which cylindrical wall is surrounded by a skirt of the upper part of the cap, which skirt is attached to the planar portion. Because the cylindrical wall serves to locate the upper part of the cap on the lower part, and also serves as a passage to guide the contents of the container during dispensing, the structure of the cap can be simplified.

In a preferred form, wherein an upper horizontal wall of the lower part extends across a part of the top of the cylindrical wall of the lower part, this upper horizontal wall serves to close the dispensing orifice when the lower and upper parts are in their first position. The upper horizontal wall can be formed integrally and simultaneously with the cylindrical wall, for example by injection molding, which simplifies manufacture.

Preferably, in order to dispense contents of the container through the sinuous passage, it is necessary for a user to move the container in a certain way, so that the contents move through the sinuous passage under gravity. In a particularly preferred form, the sinuous passage includes three vertical passages, arranged so as to be generally “N”-shaped, so that the container must be inverted three times to allow contents of the container to be dispensed through the sinuous passage.

Preferably, a lower blade extends across the passage defined by the cylindrical wall, and a lower horizontal wall extends across a part of the bottom of the cylindrical wall and is connected to the lower blade, the lower blade and the lower horizontal wall serving to partially define the sinuous passage. Again, the walls can be formed integrally and simultaneously with the cylindrical wall by injection molding, to further simplify manufacture.

In a further preferred form, the upper part of the cap is formed with a upper blade, extending downwardly from the planar portion, and a gap is formed between the top of a part of the upper blade and the underside of the planar portion, this gap serving to accommodate the upper horizontal wall when the lower part and the upper part are moved out of their first position.

The upper blade partially defines the sinuous passage, and the gap allows the lower and upper parts of the cap to be rotated relative to each other, to allow the cap to be put into a position where the sinuous passage is formed.

Preferably, rotation of the upper part by a quarter-turn relative to the lower part moves the cap from its first position to its second position, and rotation of the upper part by a further quarter-turn relative to the lower part moves the cap from its second position to its third position.

According to another aspect of this invention, one object of this invention is solved by a method for dispensing contents with a closure of a container, whereby the contents can be dosed by turning the container so that the contents can follow a sinuous path through the closure by redirecting two radially spaced barriers of the closure, whereby the closure can be closed by rotating at least one of the barriers in a first position, whereby the first of the both barriers is axially aligned and arranged to the second of the both barriers or the closure can be opened with a straight passage by rotating at least one of the barriers in another position, whereby the first of the both barriers is intersected arranged to the second of the both barriers axially like a cross.

Advantageously, with this method it is possible to use a closure, especially of a bottle, in a multifunctional manner, like it is described exemplary in regard to the following preferred embodiment.

The first barrier can be an upper blade of the closure and the second barrier can be a lower blade of the closure.

One object of this invention is also solved by a container with a mouth and a closure of the mouth, whereby the closure includes a cap according to one of the described characteristics.

One preferred application of this invention relates to a closure for granules, pellets or of that kind, not for liquids.

### BRIEF DESCRIPTION OF THE DRAWINGS

One preferred embodiment of this invention is described in view of and by reference to the accompanying drawings, in which:

FIG. 1 is a side view of an upper part of a cap of a closure of a bottle;

FIG. 2 is a side view of a lower part of the cap;

FIG. 3 is a top view of the upper part shown in FIG. 1 of the cap;

FIG. 4 is a top view of the lower part shown in FIG. 2 of the cap;

FIG. 5 is a cross-sectional view taken along line A-A shown in

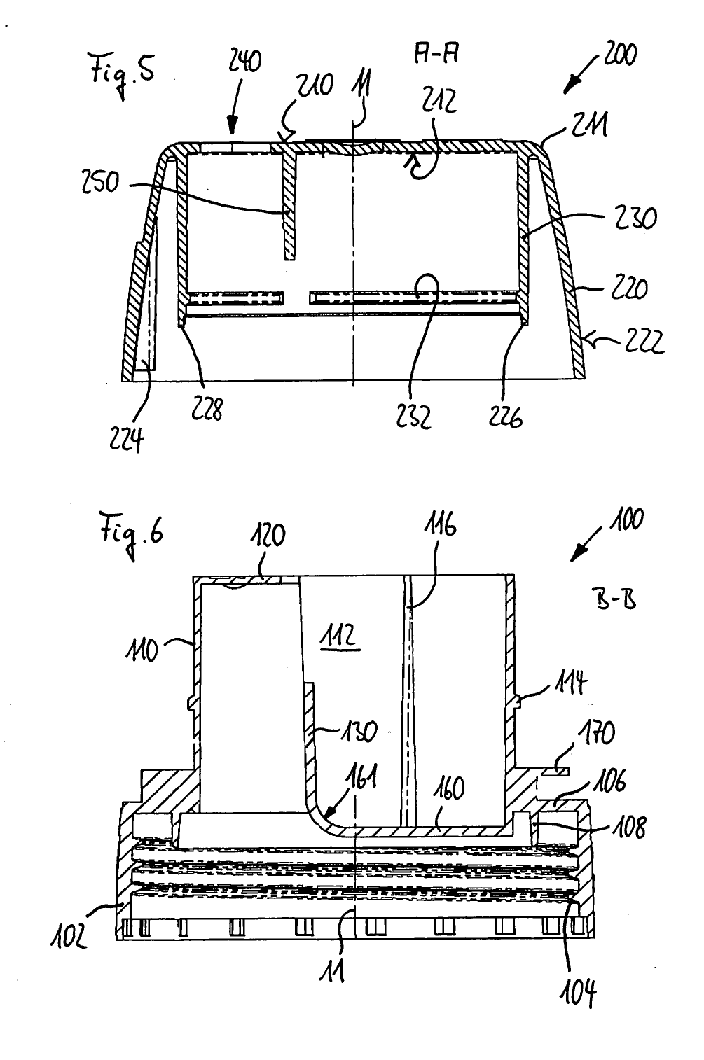

FIG. 3;

FIG. 6 is a cross-sectional view taken along line B-B shown in

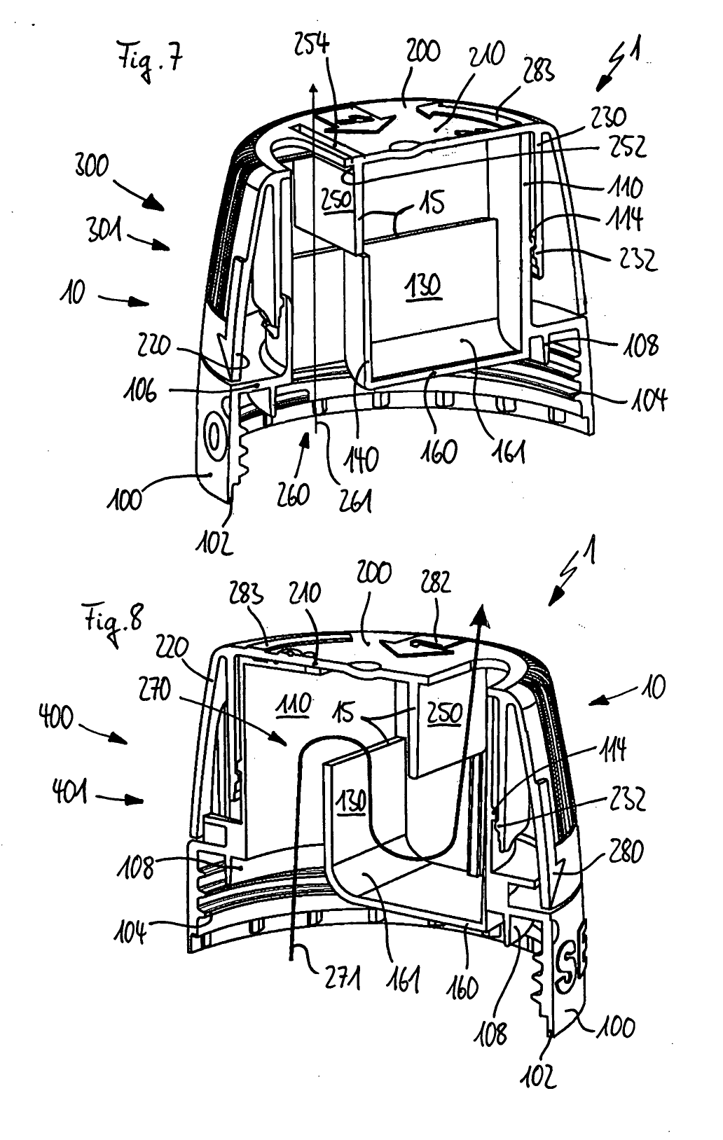

FIG. 4;

FIG. 7 is a perspective cross-sectional view of the cap in a second or pouring position; and

FIG. 8 is a perspective cross-sectional view of the cap in a third or dosed quantity position.

### DETAILED DESCRIPTION OF THE INVENTION

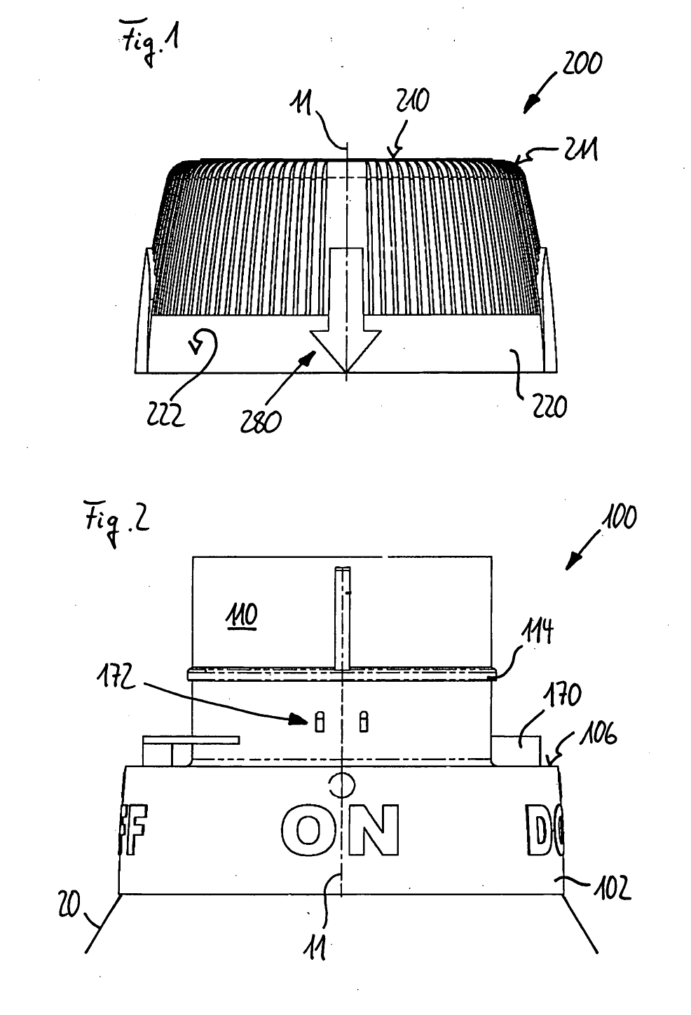

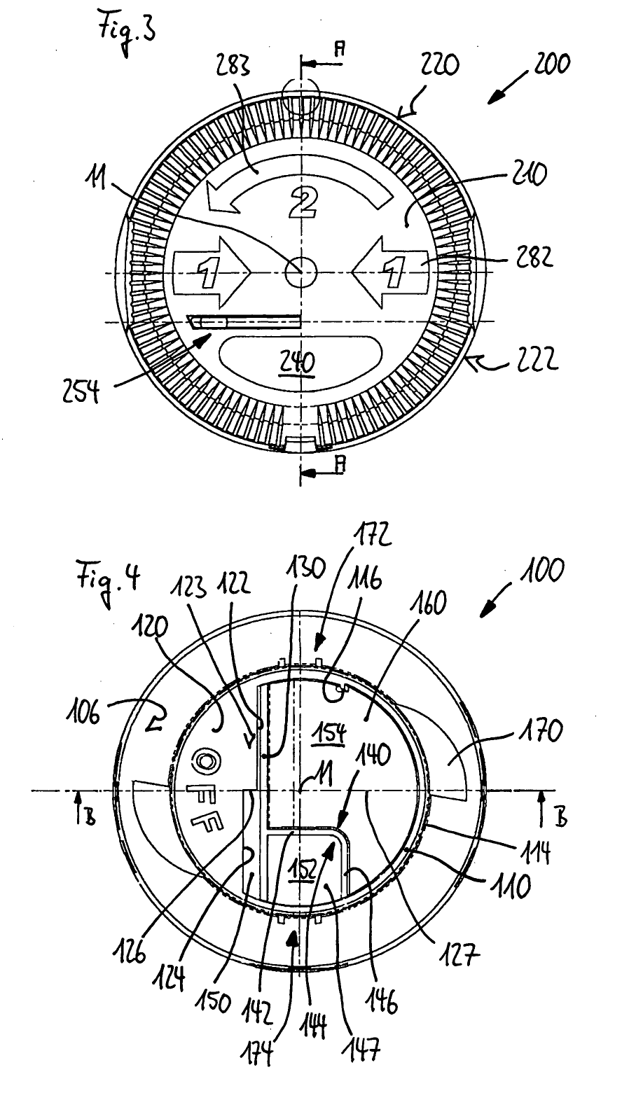

In the exemplary embodiment the closure 1, especially shown in FIGS. 7 and 8, is a cap 10 comprising two parts: a lower part 100 (especially FIGS. 2, 4 and 6), which is screwed or otherwise secured to the neck of a bottle 20 or similar container 20, and an upper part 200 (especially FIGS. 1, 3 and 5), which is secured to the lower part 100, and can be rotated relative to the lower part 100. The contents of the bottle 20 are a fluent powder or granular material. In a particularly preferred form the contents are slug pellets.

When the lower and upper parts 100, 200 are in a first position (not shown), the cap 10 is closed, and the contents of the bottle 20 cannot be dispensed.

When the lower and upper parts 100, 200 are in a second position 300, there is a straight passage 260 through the cap 10, which allows the contents of the bottle 20 to be dispensed by pouring or scattering (see FIG. 7).

When the lower and upper parts 100, 200 are in a third position 400, there is a sinuous passage 270 through the cap 10, which allows the contents of the bottle 20 to be dispensed in a preset dosed quantity (see FIG. 8).

The lower and upper parts 100, 200 of the cap 10 are now described, and the words “vertical”, “horizontal” and so on will be used in the context of the bottle 20 being upright, with the cap 10 at the top.

The lower part 100 is formed with a skirt 102 connected to the radially outer edge of a generally planar annular section 106. The skirt 102 has a thread 104 formed on its radially lower side, for engagement with the threaded neck of a bottle 20. A further skirt 108 is also formed starting from the planar annular section 106, to seal against the inside of the neck of the bottle 20.

A cylindrical wall 110 projects upwards from the radially lower edge of the generally planar annular section 106, and the cylindrical wall 110 forms a passage 112 through which the contents of the bottle 20 can be dispensed. Further walls are formed within and across the cylindrical wall 110, and these further walls serve to define the various passages 260 (FIG. 7) and 270 (FIG. 8) through the cap 10, respectively.

An upper horizontal wall 120 extends partway across the top of the cylindrical wall 110. As shown especially in FIG. 4, the shape of the upper horizontal wall 120 corresponds generally to a segment of the circle defined by the cylindrical wall 110, but the edge of the upper horizontal wall 120 corresponding to the chord is stepped, so that it is formed from two parallel chords 122, 124. The step 126 is perpendicular to the parallel chords 122, 124, and in the present case is arranged along the diameter 127 of the cylindrical wall 110 which is perpendicular to the parallel chords 122, 124.

A lower blade 130, shaped by a first vertical wall of the lower part 100, extends across the cylindrical wall 110, and is positioned vertically beneath and vertically spaced from the edge of the upper horizontal wall 120. The thickness of the lower blade 130 is the same as the length of the step 126 in the edge of the upper horizontal wall 120, and the lower blade 130 is positioned so that its sides are vertically aligned with the two parallel chords 122, 124 defining the upper horizontal wall 120.

A further vertical wall 140 is formed with a portion 142 that extends generally perpendicularly from the lower blade 130 to a curved region 144, and a portion 146 that extends from the curved region 144 to the cylindrical wall 110. The lower blade 130 and the portion 146 of the further vertical wall 140 which extends from the curved region 144 to the cylindrical wall 110 are parallel to each other, and equidistant from the diameter 127 of the cylindrical wall 110 to which they are parallel. The further vertical wall 140, the lower blade 130 and the cylindrical wall 110 forms a pouring tunnel 147.

Thus, the vertical walls 130, 140 divide the passage 112 defined by the cylindrical wall 110 into three sections: a first section 150 which is segment-shaped and is defined by the cylindrical wall 110 and the lower blade 130; and second and third sections 152, 154 which are defined by the cylindrical wall 110, the lower blade 130, and the further vertical wall 140.

The first and second sections 150, 152 are open, so that material (and in particular the contents of the container 20) can pass through them. However, the third section 154 is closed off by a lower horizontal wall 160. As best shown in FIGS. 7 and 8, the lower horizontal wall 160 is positioned slightly below the generally planar annular section 106, and the cylindrical wall 110, the lower blade 130 and the further vertical wall 140 all extend slightly below the generally planar annular section 106 to connect with the lower horizontal wall 160. Further, again best shown in FIGS. 7 and 8, the area where the lower horizontal wall 160 joins the lower blade 130 is radiused, to avoid a sharp (right-angled) join 161 between these walls 130 and 160.

The lower part 100 is also formed with a ratchet 170 and projections 172, 174 (see especially FIG. 4) at an area where the cylindrical wall 110 meets the generally annular planar portion 106. The ratchet 170 respectively and the projections 172, 174 interact with projections 224, 226, 228 on the upper part 200 of the cap 10, to hold it in the various positions.

The ratchet 170 and the projection 224 which hold the lower and upper parts 100, 200 in the first (closed) position are formed so that the upper part 200 must be deformed to disengage the ratchet 170 and the projection 224, thus providing a child-resistant feature.

The projections 172, 226 and 174, 228 which hold the lower and upper parts 100, 200 in the second and third (open) positions 300, 400 are formed so that they can be disengaged simply by rotating the lower and upper parts 100, 200 relative to each other.

The upper part 200 of the cap 10 is generally formed from a circular planar portion 210 with two skirts 220, 230 (see FIG. 5) which depend from the edge 211 of the circular planar portion 210.

The outer skirt 220 is formed with a frusto-conical shape and is shaped so that, when the lower and upper parts 100, 200 of the cap 10 are assembled, it is continuous with the skirt 102 of the lower part 100 of the cap 10, to improve the appearance of the cap 10. It is also formed with the projections 224, 226, 228 which, in co-operation with the ratchet 170 and the projections 172, 174 on the lower part 100 of the cap 10, provide the child-resistant feature.

The inner skirt 230 is generally cylindrical, and is sized to fit snugly around the cylindrical wall 110 of the lower part 100 of the cap 10. As best shown in FIGS. 5 and 7, the inner skirt 230 and the cylindrical wall 110 are formed with interacting projections 232, 114, which prevent the lower and upper parts 100, 200 of the cap 10 from coming apart but allow relative rotation.

An orifice 240 is formed in the circular planar portion 210. This orifice 240 is generally segment-shaped, and is of a size such that when the lower and upper parts 100, 200 of the cap 10 are in their closed position, the orifice 240 overlies the upper horizontal wall 120 of the lower part 100 of the cap 10 and is thus completely closed off.

An upper blade 250, shaped by a depending wall, extends downwardly from the lower surface 212 of the circular planar portion 210. The upper blade 250 extends across almost the entire width of the inner skirt 230, but is separated from the inner skirt 230 at both ends, to allow the inner skirt 230 to surround the cylindrical wall 110 of the lower part 100 of the cap 10. There is a negligible gap between the ends of the upper blade 250 and the inside of the cylindrical wall 110.

The upper blade 250 is positioned so that, when the lower and upper parts 100, 200 of the cap 10 are in their closed position, the upper blade 250 is directly above the lower blade 130 of the lower part 100 of the cap 10, and the upper blade 250 and the lower blade 130 have approximately the same thickness.

In this exemplary embodiment, the upper blade 250 and the lower blade 130 can shape the partition 15 together, when the upper blade 250 is axial aligned and arranged to the lower blade 130 (not shown).

The upper blade 250 is a first element of the partition 15 and the lower blade 130 is a further element of the partition 15.

Further, there is a gap 252 (FIG. 7) between a part of the upper blade 250 and the circular planar portion 210, and the gap 252 accommodates the upper horizontal wall 120 of the lower part 100 of the cap 10 when the lower and upper parts 100, 200 are rotated relative to each other out of their closed position.

The upper part 200 of the cap 10 is preferably formed by injection molding. In order to allow the gap 252 between the upper blade 250 and the circular planar portion 210 to be formed without using cores, a further orifice 254 is formed in the circular planar portion 210 directly above the upper blade 250. This further orifice 254 is in the form of a narrow slit and has a width approximately equal to the thickness of the upper blade 250.

When the lower and upper parts 100, 200 of the cap 10 are in their closed position, the second orifice 254 overlies the wider part 123 (see FIG. 4) of the stepped edge 122, 124, 126 of the upper horizontal wall 120 of the lower part 100 of the cap 10, and thus is also closed off by the upper horizontal wall 120.

The various positions of the lower and upper parts 100, 200 are now described.

As mentioned above, when the lower and upper parts 100, 200 are in their first position, namely a closed position (not shown), both the orifices 240, 254 in the circular planar portion 210 of the upper part 200 are closed off by the upper horizontal wall 120 of the lower part 100. Thus, the contents of the bottle 20 to which the cap 10 is attached cannot be dispensed, because there is no path through the cap 10.

In this first position the upper blade 250 and the lower blade 130 shapes two barriers of the partition 15, whereby the both barriers are axial aligned and arranged.

In order to put the cap 10 into its second position 300, namely a first open position 301 (see FIG. 7), the upper part 200 is rotated by 90 degrees anticlockwise (when viewed from above) relative to the lower part 100.

As a result of this rotation, the orifice 240 is positioned so that it is arranged vertically above a part of the first section 150 of the passage 112 through the cylindrical wall 110 and above the second section 152 of the passage 112. There is thus a straight passage 260 through the cap 10, comprising the orifice 240 and the first and second passages 150, 152, through which the contents of the bottle 20 can be poured or scattered. This straight passage 260 is indicated by straight arrow 261. A small part of the orifice 240 is still closed off by the upper horizontal wall 120, but this does not greatly impede the dispensing of the contents of the bottle 20 when it is tipped.

The flow of contents through the first section 150 of the passage 112 into the orifice 240 is controlled to some degree by the upper blade 250.

In the first open position 301, the upper blade 250 is arranged perpendicular to the lower blade 130, although it will be appreciated that the wall 130 is no longer vertical when the bottle 20 is tipped to dispense its contents, and serves to divide the first section 150 of the passage 112, preventing material above the wall from easily flowing out through the orifice 240.

In the second position 300 the two barriers are axial intersected and arranged (shown in FIG. 7).

In order to put the cap 10 into its third position 400, namely a second open position 401 (see FIG. 8), the upper part 200 is rotated by a further 90 degrees anticlockwise (when viewed from above) relative to the lower part 100.

In the second open position 401, the upper blade 250 is arranged parallel to but spaced from the lower blade 130. Further, the walls of the lower and upper parts 100, 200 of the cap 10 are positioned so that in the second open position 400, the upper blade 250 overlies the portion 146 of the further vertical wall 140 which extends from the curved region 144 to the cylindrical wall 110, and prevents direct communication between the second section 152 of the passage 112 through the cylindrical wall 110 and the orifice 240.

In the third position 400 the barriers are radially spaced and arranged (shown in FIG. 8).

As shown in FIGS. 4 and 6, there is an inward projection 116 on the cylindrical wall 110, and this serves as a stop 116 to limit motion of the upper blade 250 and ensure that it is correctly positioned. This stop 116 may be used in addition to or as an alternative to the engaging projections 174, 228 on the lower and upper parts 100, 200 of the cap 10 to locate the parts in the second open position 400.

The only way in which the contents of the bottle 20 can be dispensed through the orifice 240 when the cap 10 is in the second open position 400 is by following a sinuous path 270, through the first section 150 of the passage 112, over the top of the lower blade 130, down between the lower blade 130 and the upper blade 250, under the upper blade 250, up through the third section 154 of the passage 112 and out through the orifice 240. This passage is indicated by the sinuous arrow 271.

Of course, in order for the contents of the bottle 20 to follow this path, it is necessary, if using the cap 10 for the first time on the third position 400, for the bottle 20 to be inverted three times, to allow the contents to flow under gravity.

The first inversion leads to the cap 10 being below the bottle 20, and the contents flow downwards through the first and second sections 150, 152 of the passage 112 and accumulate on the region of the circular planar portion 210 and on the upper horizontal wall 120 bounded by the cylindrical wall 110 and the upper blade 250.

After the second inversion, the cap 10 is again above the bottle 20. The contents which had previously accumulated on the circular planar portion 210 and the upper horizontal wall 120 fall downwards, and some of the contents fall back through the first and second sections 150, 152 of the passage 112 into the bottle 20. However, some fall through the gap 252 (FIG. 7) between the lower blade 130 and the upper blade 250, and accumulate on the lower horizontal wall 160. The radiused join or joint between the lower blade 130 and the lower horizontal wall 160 will tend to urge falling contents away from the lower blade 130, so that they accumulate beneath the orifice 240.

After the third inversion, the cap 10 is again below the bottle 20, and the contents which had accumulated on the lower horizontal wall 160 falls downwards. Again, some will fall back through the gap 252 between the lower blade 130 and the upper blade 252, but most will fall through the orifice 240 and thus out of the cap 10. Thus, it is possible to dispense a small amount of the contents of the bottle 20.

Furthermore, after the third inversion, some of the contents of the bottle 20 will have accumulated on the region of the circular planar portion 210 bounded by the cylindrical wall 110 and the upper blade 250, as they did after the first inversion. Thus, two more inversions of the bottle 20 will allow a further small amount of the contents to be dispensed. This process can be repeated as many times as desired, to dispense a desired quantity of the contents of the bottle 20 in small amounts.

Also, the amount of contents dispensed is roughly the same each time, as the amount is determined by the dimensions of the various walls defining the sinuous passage 270. Thus, it is possible to design the parts of the cap 10 so that a desired dose of contents is dispensed each time. Of course, this desired dose may vary depending on the product to be dispensed, and so caps with walls of differing dimensions can be provided for use with different products.

In other words to get a dose the following is needed:

a) First time on third position (total=three times):
put the bottle 20 upside down;
put the bottle 20 upright; and
put the bottle 20 upside down again;

b) After this first time (total=two times):
put the bottle upright; and
put the bottle upside down.

As shown in the drawings, an arrow 280 can be formed on the frusto-conical outer surface 222 of the outer skirt 220 of the upper part 200 of the cap 10, for example by molding, and the arrow 280 can be moved to point at different indicia on the skirt 102 of the lower part 100 of the cap 10 (shown as “OFF” for the closed position, “ON” for the first open position, and “DOSE” for the second open position). In addition, arrows 282 and 283 indicating the motions necessary to rotate the upper part 200 on the lower part 100 can also be formed on the cap 10, as shown in FIG. 3.

The lower and upper parts 100, 200 of the cap 10 are formed separately, preferably by injection molding as mentioned above. The parts 100, 200 are then assembled together by pressing the upper part 200 onto the lower part 100 until the interacting projections 232, 114 engage together, to retain the upper part 200 on the lower part 100. The assembled cap 10 can then be screwed on to the bottle 20.

The cap 10, especially the lower and upper parts 100, 200 of the cap 10, and the opening of the bottle 20 have an identical main axis 11.

What is claimed is:

1. A cap (10) for a container (20) with a mouth such as a bottle, comprising a lower part (100) for attachment to the mouth of the container (20), and an upper part (200) provided on and rotatable relative to the lower part (100), wherein the upper part (200) has a dispensing orifice (240) and the upper part (200) can be rotated into:
a first position having no passage through the cap (10) and contents of the container (20) that cannot be dispensed from the dispensing orifice (240);
a second position (300) having a straight passage (260, 261) through the cap (10) and the contents of the container (20) can be dispensed from the dispensing orifice by pouring or scattering; and
a third position (400) having a sinuous passage (270, 271) through the cap (10), and the contents of the container (20) can be dispensed from the dispensing orifice (240) in a preset dosed quantity.

2. A cap (10) for a container (20) with a mouth such as a bottle, comprising a lower part (100) for attachment to the mouth of the container (20), an upper part (200) provided on the lower part (100) and a partition (15) within the cap (10) to divide the cap (10) into a first section (150) and into at least one further section (152, 154), wherein the upper part (200) has a dispensing orifice (240), the partition (15) comprises a first element (250) and at least a further element (130), and the elements (130, 250) are arranged moveable with respect to each other to provide either a straight passage (260, 261) or a sinuous passage (270, 271) through the cap (10).

3. A cap (10) as claimed in claim 2, wherein the first element (250) of the partition (15) is rotatable opposite the further element (130) of the partition (15) to provide either the straight passage (260) or the sinuous passage (270) through the cap (10).

4. A cap (10) as claimed in claim 3, wherein the first element (250) of the partition (15) is rotatable about a main axis (11) of the cap (10).

5. A cap (10) as claimed in claim 4, wherein the elements (130, 250) of the partition (15) are radially spaced apart from the main axis (11) of the cap (10).

6. A cap (10) as claimed in claim 5, wherein the first element (250) of the partition (15) comprises the upper part (200) and the further element (130) of the partition (15) comprises the lower part (100).

7. A cap (10) as claimed in claim 6, wherein the lower part (100) and the upper part (200) are generally rotationally symmetric about the main axis (11) of the cap (10) and/or of an opening of the container (20), the upper part (200) rotates about the main axis (11), and the dispensing orifice (240) of the upper part (200) is provided in a planar portion (210) generally perpendicular to the main axis (11).

8. A cap (10) as claimed in claim 7, wherein the lower part (100) of the cap (10) has a cylindrical wall (110) defining a passage (112) therethrough, and the cylindrical wall (110) is surrounded by a skirt (230) of the upper part (200) of the cap (10), and the skirt (230) is attached to a planar portion (210) of the upper part (200).

9. A cap (10) as claimed in claim 8, wherein an upper horizontal wall (120) of the lower part (100) extends across a part of a top of a cylindrical wall (110) of the lower part (100), and the upper horizontal wall (120) serves to close the dispensing orifice (240) when the lower and upper parts (100, 200) are in a first position.

10. A cap (10) as claimed in claim 9, wherein a lower blade (130) extends across the passage (112) defined by the cylindrical wall (110), and a lower horizontal wall (160) extends across a part of the bottom of the cylindrical wall (110) and is connected to the lower blade (130), and the lower blade (130) and the lower horizontal wall (160) partially define the sinuous passage (270, 271).

11. A cap (10) as claimed in claim 10, wherein the upper part (200) of the cap (10) is formed with an upper blade (250) extending downwardly from the planar portion (210), and a gap (252) is formed between the top of a part of the upper blade (250) and an underside (212) of the planar portion (210), and the gap (252) serves to accommodate the upper horizontal wall (120) when the lower part (100) and the upper part (200) are moved out of the first position.

12. A cap (10) as claimed in claim 11, wherein rotation of the upper part (200) by a quarter-turn relative to the lower part (100) moves the cap (10) from the first position to the second position (300), and rotation of the upper part (200) by a further quarter-turn relative to the lower part (100) moves the cap (10) from the second position (300) to the third position (400).

13. A cap (10) for a bottle or similar container (20) according to claim 1, substantially as described herein with reference to the accompanying drawings.

14. A container (20) with a mouth and a closure (1) of the mouth, comprising a cap (10) according to claim 1.

15. A method for dispensing contents with a closure (1) of a container (20), wherein contents can be dosed by turning the container (20) so that the contents can follow a sinuous path (270, 271) through the closure (1) by redirecting of two radially spaced barriers (130, 250) of the closure (1), comprising the closure (1) can be closed by rotating at least one of the barriers (130, 250) in a first position, wherein the first barrier (250) of the barriers (130, 250) is axially aligned to the second barrier (130) of the barriers (130, 250), or the closure (1) can be opened with a straight passage (260, 261) by rotating at least one of the barriers (130, 250) in another position (300), whereby the first barrier (250) of the barriers (130, 250) is arranged intersected to the second barrier (130) of the barriers (130, 250) axially.

16. A cap (10) as claimed in claim 2, wherein the first element (250) of the partition (15) is rotatable about a main axis (11) of the cap (10).

17. A cap (10) as claimed in claim 2, wherein the elements (130, 250) of the partition (15) are radially spaced apart from the main axis (11) of the cap (10).

18. A cap (10) as claimed in claim 2, wherein the first element (250) of the partition (15) comprises the upper part (200) and the further element (130) of the partition (15) comprises the lower part (100).

19. A cap (10) as claimed in claim 1, wherein the lower part (100) and the upper part (200) are generally rotationally symmetric about the main axis (11) of the cap (10) and/or of an opening of the container (20), the upper part (200) rotates about the main axis (11), and the dispensing orifice (240) of the upper part (200) is provided in a planar portion (210) generally perpendicular to the main axis (11).

20. A cap (10) as claimed in claim 1, wherein the lower part (100) of the cap (10) has a cylindrical wall (110) defining a passage (112) therethrough, and the cylindrical wall (110) is surrounded by a skirt (230) of the upper part (200) of the cap (10), and the skirt (230) is attached to a planar portion (210) of the upper part (200).

21. A cap (10) as claimed in claim 1, wherein an upper horizontal wall (120) of the lower part (100) extends across a part of a top of a cylindrical wall (110) of the lower part (100), and the upper horizontal wall (120) serves to close the dispensing orifice (240) when the lower and upper parts (100, 200) are in a first position.

22. A cap (10) as claimed in claim 8, wherein a lower blade (130) extends across the passage (112) defined by the cylindrical wall (110), and a lower horizontal wall (160) extends across a part of the bottom of the cylindrical wall (110) and is connected to the lower blade (130), and the lower blade (130) and the lower horizontal wall (160) partially define the sinuous passage (270, 271).

23. A cap (10) as claimed in claim 2, wherein rotation of the upper part (200) by a quarter-turn relative to the lower part (100) moves the cap (10) from the first position to the second position (300), and rotation of the upper part (200) by a further quarter-turn relative to the lower part (100) moves the cap (10) from the second position (300) to the third position (400).

24. A cap (10) as claimed in claim 1, wherein rotation of the upper part (200) by a quarter-turn relative to the lower part (100) moves the cap (10) from the first position to the second position (300), and rotation of the upper part (200) by a further quarter-turn relative to the lower part (100) moves the cap (10) from the second position (300) to the third position (400).
